(19) United States
(12) Patent Application Publication
(10) Pub. No.: US 2026/0209037 A1
(43) Pub. Date: Jul. 23, 2026

(54) SYSTEM AND METHOD FOR STORING AND RECOVERING HYDROGEN

(71) Applicant: ARIEL SCIENTIFIC INNOVATIONS LTD., Ariel (IL)

(72) Inventors: Nir TZABAR, Ariel (IL); Avshalom DAVIDESKO, Ariel (IL)

(21) Appl. No.: 19/140,922

(22) PCT Filed: Dec. 19, 2023
(86) PCT No.: PCT/IL2023/051283

§ 371 Date: Jun. 18, 2025

Related U.S. Application Data
(60) Provisional application No. 63/433,591, filed on Dec. 19, 2022.

(51) Int. Cl. C01B 3/0021; B01J 20/20

(52) U.S. Cl. CPC C01B 3/0021; B01J 20/20

(57) ABSTRACT

A system for storing and recovering hydrogen is disclosed. The system may include: a hydrogen inlet; a first phase change material (PCM) unit configured to regenerate the hydrogen to a first temperature; a compressor fluidically connected at one of: between the hydrogen inlet and the first PCM unit, for providing a first pressure level to the hydrogen; or to the at least the first PCM unit via a cooler for providing the first pressure level to cooled hydrogen, and a hydrogen sorbent bed (HSB) storage configured to receive a depressurized cooled hydrogen from one of, the first PCM unit or the compressor, wherein the hydrogen pressure level at the entrance to the HSB storage is at most 80 bar and the temperature at the entrance to the HSB storage is between 20 to 180 K.

### CROSS-REFERENCE TO RELATED APPLICATIONS

This application claims the benefit of priority of U.S. Patent Application No. 63/433,591, filed Dec. 19, 2022, which is hereby incorporated by reference in its entirety.

### FIELD OF THE INVENTION

The present invention relates generally to methods and systems for storing and recovering hydrogen. More specifically, the present invention relates to methods and system for storing and recovering hydrogen using phase change material (PCM) units.

### BACKGROUND OF THE INVENTION

The ability to store and recover hydrogen is a key issue in the ability to utilize hydrogen as a source of energy production that can replace the currently used fossil fuels. Stored hydrogen that can be easily recovered may power fuel cells for the production of clean electric energy. Therefore, hydrogen is a means to store energy. It is produced when energy is available, it is stored as hydrogen, and it is converted back to electricity, by fuel cells, when energy is required or as a fuel in combustion engines.

An alternative option to hydrogen is the storage of compressed air energy storage (CAES) in order to power turbines for producing electricity. The efficiencies of the CAES systems are between 70% to 85%.

Another mature large-scale energy storage alternative technology is the pumped hydropower energy storage (PHES). These technologies depend on geographic characteristics, and therefore, are not suitable for any location. The efficiencies of the PHES systems are also between 70% to 85%.

One newly developed technology based on a cryogenic energy storage system (CES) was used to liquefy air, as an available energy source. The liquid air is stored at about −196° C., and the energy is recovered by evaporating the air while exposed to the ambient air. The CES technology offers 4 hours to 4 weeks of energy supply and claims to have about 25% efficiency and a relatively high energy density: about 100 kWh/m³.

Accordingly, an energy storage technique is suggested having a reduced operating power consumption (high efficiency), that can be implemented in any location, and doesn't require any geographical structure. Such a technology can be implemented in both small-scale platforms (e.g., in transportation) of large-scale facilities (e.g., power plants).

### SUMMARY OF THE INVENTION

Some aspects of the invention may be directed to a system for storing and recovering hydrogen, comprising: a hydrogen inlet; a first phase change material (PCM) unit configured to regenerate the hydrogen to a first temperature; a compressor fluidically connected at one of: between the hydrogen inlet and the first PCM unit, for providing a first pressure level to the hydrogen; or to the at least the first PCM unit via a cooler for providing the first pressure level to cooled hydrogen, and a hydrogen sorbent bed (HSB) storage configured to receive a depressurized cooled hydrogen from one of, the first PCM unit or the compressor, wherein the hydrogen pressure level at the entrance to the HSB storage is at most 80 bar and the temperature at the entrance to the HSB storage is between 20 to 180 K.

In some embodiments, when the compressor is fluidically connected to the hydrogen inlet, the system further comprises a turbine configured to reduce the pressure of the hydrogen to 2-80 bar and the temperature to between 50 to 180 K. In some embodiments, the compressor is configured to compress the hydrogen to a pressure between 50 to 700 bar. In some embodiments, the system further comprises a generator axially connected to the first turbine, for generating electrical energy.

In some embodiments, when the compressor is fluidically connected to the hydrogen inlet, the system further comprises a cooler fluidically connected to the first PCM unit configured to reduce the temperature of the hydrogen to between 20 to 180 K and wherein the compressor increases the pressure of the hydrogen to 2-80 bar.

In some embodiments, when the compressor is fluidically connected to the at least the first PCM unit via a cooler, the compressor is configured to increase the pressure of the hydrogen to 2-80 bar and the cooler configured to reduce the temperature of the hydrogen to between 20-180 K.

In some embodiments, wherein the first temperature is between 50 to 250 K. In some embodiments, the system further comprises a second PCM unit configured to regenerate the hydrogen to a second temperature, in fluid connection with the first PCM unit. In some embodiments, wherein the first temperature is between 100 to 250 K and the second temperature is between 50 to 200 K. In some embodiments, the system further comprises a third PCM unit configured to regenerate the hydrogen to a third temperature, in fluid connection with the second PCM unit. In some embodiments, the first temperature is between 150 to 250 K, the second temperature is between 100 to 200 K and the third temperature is between 50 to 180 K.

In some embodiments, the system comprising NPCMs, and wherein the temperature Tₙ of the n PCM is determined from:

$${\int }_{{T}_{n - 1}}^{{T}_{n}} {c}_{p} d T - {\int }_{{T}_{n}}^{{T}_{s t o r a g e}} {c}_{p} d T = 0 ,$$

where cₚ is the hydrogen specific heat capacity in

$$( \frac{J}{k g K} ) ,$$

T_{storage} is the required temperature at the HSB storage, and n=N and wherein N is an integer.

In some embodiments, the system further comprises an exit turbine or a pressure reduction valve in fluid connection to the first PCM unit and configured to receive hydrogen stored in the hydrogen storage and reheated by the first PCM unit. In some embodiments, the exit turbine or the pressure reduction valve is configured to reduce the pressure of the heated stored hydrogen to 1 to 15 bar.

Some additional aspects of the invention are directed to a method of storing and recovering hydrogen, comprising: cooling by one or more PCM units hydrogen to a first temperature; reducing the cooled hydrogen to between 20 to 180 K, using one of a cooler or a turbine; compressing hydrogen to a pressure level of 2-80 bar, at one of: prior to the cooling by the one or more PCM units, and after cooling by a cooler; and storing the hydrogen having a pressure of 2-80 bar and a temperature of between 50 to 180 K in hydrogen sorbent bed (HSB) storage.

In some embodiments, compressing the hydrogen is by one of: a compressor receiving the hydrogen from a hydrogen source prior to the cooling by the first PCM, or by a compressor located after the cooler. In some embodiments the method further comprises generating electrical energy by a generator axially connected to the turbine. In some embodiments the first temperature is between 50 to 250 K.

In some embodiments, the method further comprises cooling the hydrogen from the first PCM by a second PCM to a second temperature, therefore, the first temperature is between 100 to 250 K and the second temperature is between 50 to 200 K. In some embodiments, the method further comprising cooling the hydrogen from the second PCM using a third PCM a third temperature and therefore, the first temperature is between 150 to 250 K, the second temperature is between 100 to 200 K and the third temperature is between 50 to 180 K.

In some embodiments, the method comprising N cooling cycles using NPCMs, and wherein the temperature Tₙ of the n PCM is determined from:

$${\int }_{{T}_{n - 1}}^{{T}_{n}} {c}_{p} d T - {\int }_{{T}_{n}}^{{T}_{storage}} {c}_{p} d T = 0 ,$$

where cₚ is the hydrogen specific heat capacity in

$$( \frac{J}{k g K} ) ,$$

and wherein T_{storage} is the required temperature at the HSB storage and n=N, wherein N is an integer.

In some embodiments, the method further comprises:
(a) discharging the hydrogen from the HSB storage;
(b) heating the hydrogen to at least the first temperature by the second PCM unit; and
(c) decompressing the hydrogen to an exit pressure of between 1 to 15 bar using an exit turbine.

In some embodiments, the method further comprises providing hydrogen to a fuel-cell for producing electricity. In some embodiments, the method further comprises heating the HSB storage during discharge phase. In some embodiments, the method further comprises generating electrical energy by a generator axially connected to the exit turbine. In some embodiments, the method further comprises providing the decompressed hydrogen to one or more fuel cells for generating electrical energy.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A, 1B, and 1C are block diagrams depicting systems for storing and recovering hydrogen according to some embodiments of the invention;

FIG. 2 is a flowchart of a method for storing and recovering hydrogen according to some embodiments;

FIGS. 3A, 3B, 3C and 3D are graphs showing the temperature for each PCM is a system of 2, 3, 4, and 5 PCMs respectively, according to some embodiments of the invention; and.

FIGS. 4A, 4B, 4C and 4D are graphs showing efficiency calculations for systems with 2, 3, 4, and 5 PCMs, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

Aspects of the invention are related to a method and system for storing and recovering hydrogen. Such a system can provide recovered hydrogen to fuel cells, or to other consumers, for the production of electric energy. In some embodiments, the system may include one or more turbines, powered by compressed hydrogen that may further be axially connected to one or more generators for generating additional electric energy, thus, improving the efficiency of the system. The system may be implemented in any location and doesn't require any specific geographical structure. In some embodiments, the technology is scalable and suitable for implementation in both small-scale platforms (e.g., transportation platforms) or large-scale facilities (e.g., power plants).

In some embodiments, hydrogen at cryogenic temperatures is used in order to obtain elevated hydrogen densities at temperatures below the critical temperature of hydrogen (33.2 K, −239.95° C.), and pressures of a few bar, only. The hydrogen may be stored at adsorbed phase on a sorbent bed. The suggested technology may combine two existing energy storage technologies: hydrogen stored at high pressures (normally, 350-700 bar), and CAES, as mentioned hereinabove. The hydrogen energy storage systems and CAES benefit the independency from topography and any other restrictions and thus may be implemented anywhere. A system according to embodiments of the invention maintains this characteristic but includes storage under much lower pressures of at most 80 bar, which is favorable.

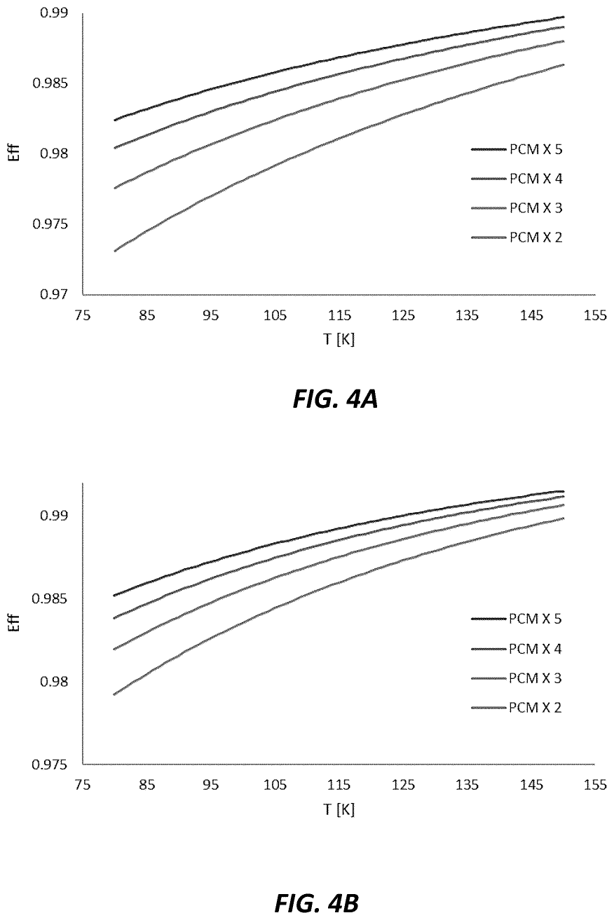

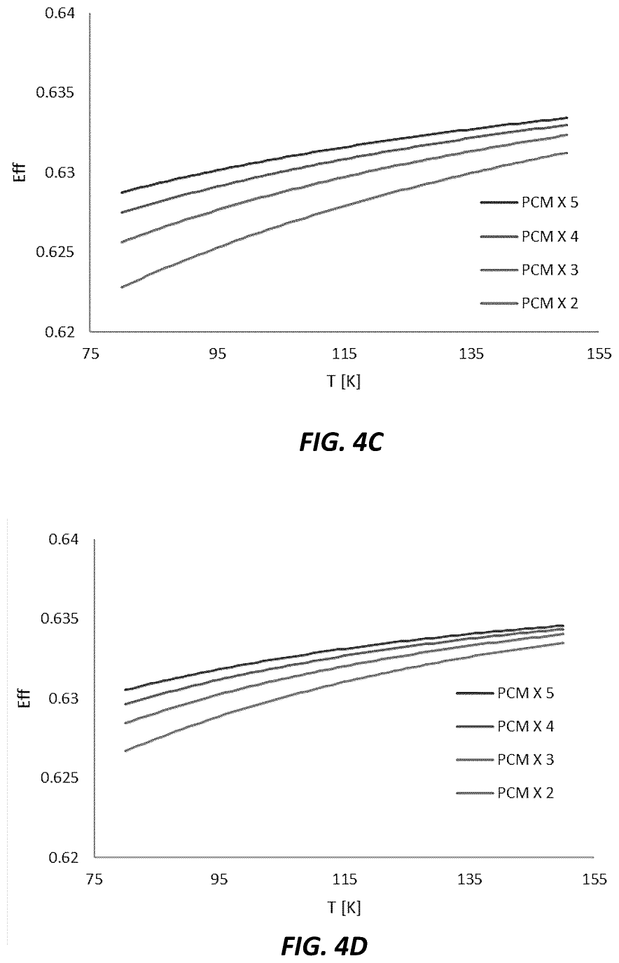

In some embodiments, the system has improved storing/recovery efficiency in comparison to prior art methods. The system's efficiency is defined by the energy which is supplied by the system, relative to the energy which is discharged from the system. Existing hydrogen energy storage show efficiencies of about 50%, where CAES show efficiencies of about 54%. The efficiency of the suggested invention is about 63%, which is mainly governed by the production of hydrogen and the conversion of hydrogen into electricity, in fuel cells. If one considers the efficiency of hydrogen storage only, then the efficiency of the suggested invention is about 98%, relative to 96% for existing hydrogen systems. Nonlimiting examples for efficiency calculations according to some embodiments of the invention are given herein below with respect to FIGS. 4A-4D.

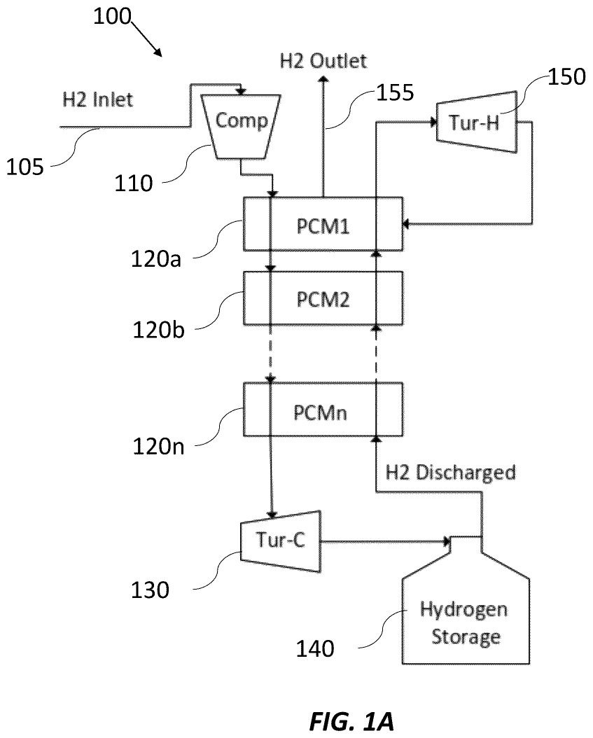

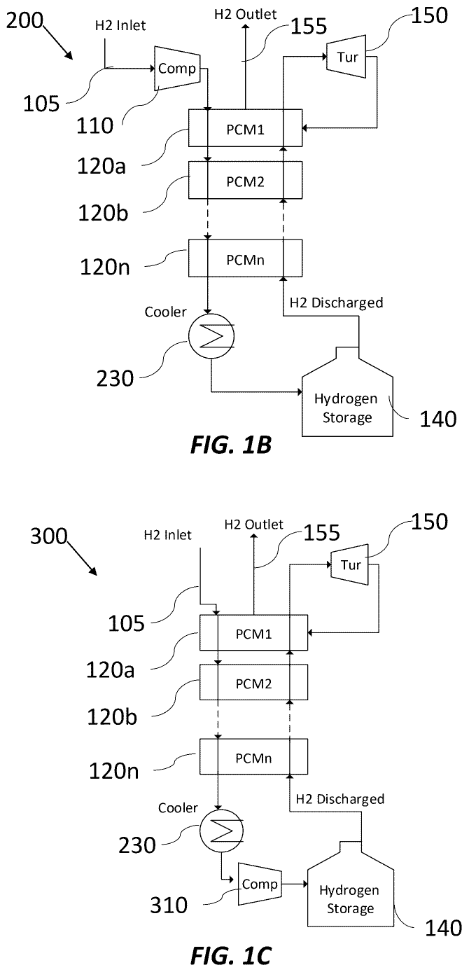

Reference is now made to FIG. 1A which is a block diagram depicting a system for storing and recovering hydrogen according to some embodiments of the invention. A system 100 may include a hydrogen inlet 105 and a compressor 110 fluidically connected between hydrogen inlet 105 and a phase change material (PCM) unit 120a, for providing a first pressure level to the hydrogen. In some embodiments, system 100 may include a hydrogen sorbent bed (HSB) storage 140 configured to receive a depressurized cooled hydrogen from first PCM unit 120a, via, for example, a turbine 130. Turbine 130 is configured to reduce the pressure of the hydrogen to at most 80 bar (e.g., from 2 to 80 bar and any value in-between) and the temperature to between 50 to 180 K, as discussed herein below.

Hydrogen inlet 105 may provide hydrogen from any type of hydrogen source, for example, a tank, hydrogen production facility, and the like.

Compressor 110 may allow compressing gasses such as hydrogen to a pressure between 50 to 700 bar, for example, 60 bar, 80 bar, 100 bar, 150 bar, 200 bar, 300 bar, 400 bar, 500 bar, 600 bar or any value in between.

In some embodiments, the pressurized hydrogen may be provided to a first PCM unit 120a. In some embodiments, system 100 may include an array of PCMs units 102a-102n. In some embodiments, when system 100 includes a single PCM unit the first temperature is between 50 to 250 K. In some embodiments, system 100 may further include a second PCM unit 120b configured to regenerate the hydrogen to a second temperature, in fluid connection with first PCM unit 120a. In such a case, the first temperature is between 100 to 250 K and the second temperature is between 50 to 200 K.

In some embodiments, system 100 may further include a third PCM unit 120c configured to regenerate the hydrogen to a third temperature, in fluid connection with second PCM unit 120b. In such a case, the first temperature is between 150 to 250 K, the second temperature is between 100 to 200 K and the third temperature is between 50 to 180 K.

In some embodiments, system 100 may include N PCM units, when N is an integer≥1).

In order to evaluate the temperature of each PCM unit, two assumptions were taken. The first assumption is that the enthalpy change of the hydrogen stream in the charging stage is equal to the one in the discharging stage, in each PCM unit. In some embodiments, the loses over the storage duration for each PCM unit are considered when designing the overall components of system 100. The second assumption is that the temperature of the hydrogen stream at the exit from the PCM unit is equal to the temperature of the PCM unit. Therefore, the PCM unit/s temperature/s of the n PCM unit (where 1≤n≤N) can be calculated according to the following equations:

$${\int }_{{T}_{0}}^{{T}_{1}} {c}_{p} d T - {\int }_{{T}_{1}}^{{T}_{2}} {c}_{p} d T = 0 \qquad ( 1 )$$

$${\int }_{{T}_{1}}^{{T}_{2}} {c}_{p} d T - {\int }_{{T}_{2}}^{{T}_{3}} {c}_{p} d T = 0 \qquad ( 2 )$$

$$⋮$$

$${\int }_{{T}_{n - 1}}^{{T}_{n}} {c}_{p} d T - {\int }_{{T}_{n}}^{{T}_{storage}} {c}_{p} d T = 0 \qquad ( n )$$

Where cₚ is the hydrogen specific heat capacity

$$( \frac{J}{k g K} ) ,$$

T₀ is the inlet hydrogen temperature (probably, ambient temperature) (K), T_{storage} is the hydrogen storage temperature (K), T_{1, 2 . . . , n} is the PCMs temperatures (K) and n is the number of PCMs.

In some embodiments, the materials for each PCM unit may be selected according to the required temperature. In some embodiments, PCMs for cryogenic temperatures are alcohol-based.

In some embodiments, from the last PCM unit (e.g., 102n for N=n PCMs) the cooled hydrogen may enter turbine 130 in order to reduce the pressure of the hydrogen to at most 80 bar (e.g., 2 to 80 bar) and the temperature to between 50 to 180 K. Accordingly, the hydrogen pressure level at the entrance to HSB storage 140 is at most 80 bar and the temperature at the entrance to the HSB storage is between 20 to 180 K. In some embodiments, turbine 130 may be axially connected to a generator (not illustrated) for additional production of electricity.

In some embodiments, HSB storage 140 may include any type of sorbent bed that is configured to absorb hydrogen having a pressure of 2 to 80 bar and a temperature of between 50 to 180 K. For example, HSB storage 140 may include, activated carbons, with pore sizes which are suitable to the small dimensions of the hydrogen molecule, Metal Organic Framework (MOF), Carbon nanotubes (CNT), Carbon nanofibers (CNF), Graphene and the like.

In some embodiments, from HSB storage 140 the stored hydrogen may be warmed up via PCM units 102a-102n, until reaching a required temperature of maximum 250 K. In some embodiments, the hydrogen from PCM unit 102a may flow to an exit turbine 150 or to a pressure reduction valve, configured to reduce the pressure of the heated stored hydrogen to 1 to 15 bar. Therefore, the hydrogen pressure in an outlet 155 from system 100 is between 1 to 15 bar (e.g., the pressure in which the hydrogen is required, for example, by the fuel cell) and the hydrogen temperature is between T_{PCM-1} and the ambient temperature. The required pressure/temperature may be determined according to the hydrogen consumer. For example, system 100 may provide hydrogen to one or more fuel cells at 1 bar and 300 K.

In some embodiments, exit turbine 150 may be axially connected to another generator (not illustrated) for producing electricity. In some embodiments, the energetic efficiency of system 100 is affected by a direct production of electricity from hydrogen via a fuel cell, electricity produced by the generator axially connected to turbine 110, and the generator axially connected to turbine 150.

As should be understood by one skilled in the art, the specific structure of system 100 is given as an example only, and other arrangements of the components of system 100 are within the scope of the invention, for example, the structures illustrate and discussed with respect to FIGS. 1B and 1C. In some embodiments, the energy produced by the generator that is axially connected to turbine 150 may be provided to one of: (a) back to system 100 (e.g., to compressor 110) in order to reduce the energy consumption of system 100 during the storing stage, (b) provided directly to the grid, (c) consume by an external consumer (e.g., an electrolyzed providing the hydrogen), (d) provided to the cooler, (e) provided to other internal consumers (e.g., valves, controller, flow controllers, etc.), and the like.

Reference is now made to FIG. 1B which is a block diagram depicting a system for storing and recovering hydrogen according to some embodiments of the invention. A system 200 may include a hydrogen inlet 105 and a compressor 110 fluidically connected between hydrogen inlet 105 and one or more PCM units 120a-120n, for providing a first pressure level to the hydrogen. In some embodiments, system 100 may include HSB storage 140 configured to receive a depressurized cooled hydrogen from one or more PCM units 120a-120n at a pressure of at most 80 bar (e.g., from 2 to 80 bar and any value in-between) and the temperature to between 20 to 180 K. Hydrogen inlet 105, compressor 110, PCM units 120a-120n and HSB storage 140 of system 200 are substantially the same as hydrogen inlet 105, compressor 110, PCM units 120a-120n and HSB storage 140 of system 100.

In some embodiments, system 200 may include a cooler 230 fluidically connected between PCM 120n (1≤n≤N) and HSB storage 140. Cooler 230 may be configured to reduce the temperature of the hydrogen to between 20-180 K, if a further cooling is required, for example, when the temperature of PCM 120n is 160 K, cooler 230 may cool the hydrogen to 120 K. In such case the pressure of the hydrogen leaving compressor 110 is at a pressure of at most 80 bar (e.g., from 2 to 80 bar and any value in-between).

Reference is now made to FIG. 1C which is a block diagram depicting a system for storing and recovering hydrogen according to some embodiments of the invention. A system 300 may include a hydrogen inlet 105 and one or more PCM units 120a-120n fluidically connected between hydrogen inlet 105 and a compressor 310, for example, via a cooler 230. Hydrogen inlet 105 and one or more PCM units 120a-120n may be substantially the same as hydrogen inlet 105 and PCM units 120a-120n of system 100 discussed herein above. Cooler 230 may be substantially the same as cooler 230 of system 200 discussed herein above. Compressor 310 may be configured to compress the hydrogen to at most 80 bar (e.g., from 2 to 80 bar and any value in-between). In some embodiments, outlet pressure from compressor 110 of the system 200 is much lower than the outlet pressure from compressor 110 the system 100. The outlet pressure from compressor 110 of the system 200 is at most 80 bar in comparison to typically 100 to 350 bar of compressor 110 of system 100. Therefore, the entire system works at lower pressure, which result in lower wear of system 200 components (e.g., pipes, valves, etc.), thus the use of simpler and cheaper components and/or having a system with higher operation duration.

In some embodiments, system 300 may include HSB storage 140 configured to receive a cooled hydrogen from compressor 310 at a pressure of at most 80 bar (e.g., from 2 to 80 bar and any value in-between) and the temperature to between 20 to 180 K. In such case the hydrogen is provided to one or more PCM units 120a-120n at the inlet pressure, further cooled down by cooler 230 to a temperature of between 20-180 K and pressurized to 2 to 80 bar by compressor 310. HSB storage 140 of system 300 is substantially the same as HSB storage 140 of system 100. In some embodiments, system 300 works at the lowest pressure in comparison to system 100 and system 200, as the compression is conducted prior to HSB storage 140. Therefore, the PCMs and the cooler are not exposed to high pressures at all.

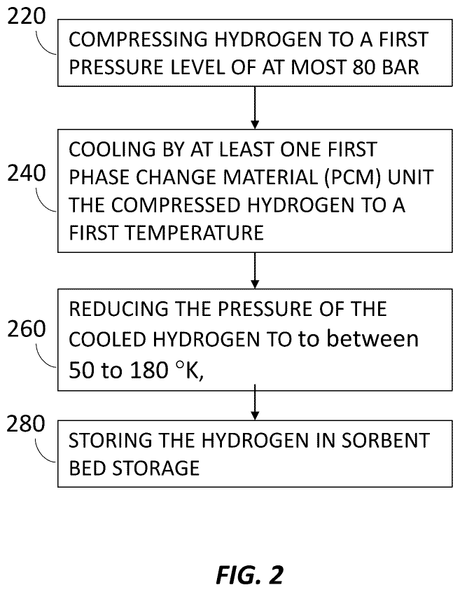

Reference is now made to FIG. 2 which is a flowchart of a method of storing and recovering hydrogen according to some embodiments of the invention. The method of FIG. 2 may be performed using any one of systems 100, 200 and 300 or by any other suitable system having one or more PCMs, a compressor and a HSB storage.

In step 220, hydrogen is cooled to a first temperature by one or more PCM units. For example, hydrogen from inlet 105 may be received at first PCM unit 120a, as illustrated in FIG. 1C, or may be received first at compressor 110, as illustrated in FIGS. 1A and 1B, to be provided to at first PCM unit 120a. In some embodiments, when systems 100, 200 and 300 include only one PCM unit 120a, the first temperature is between 50 to 250 K.

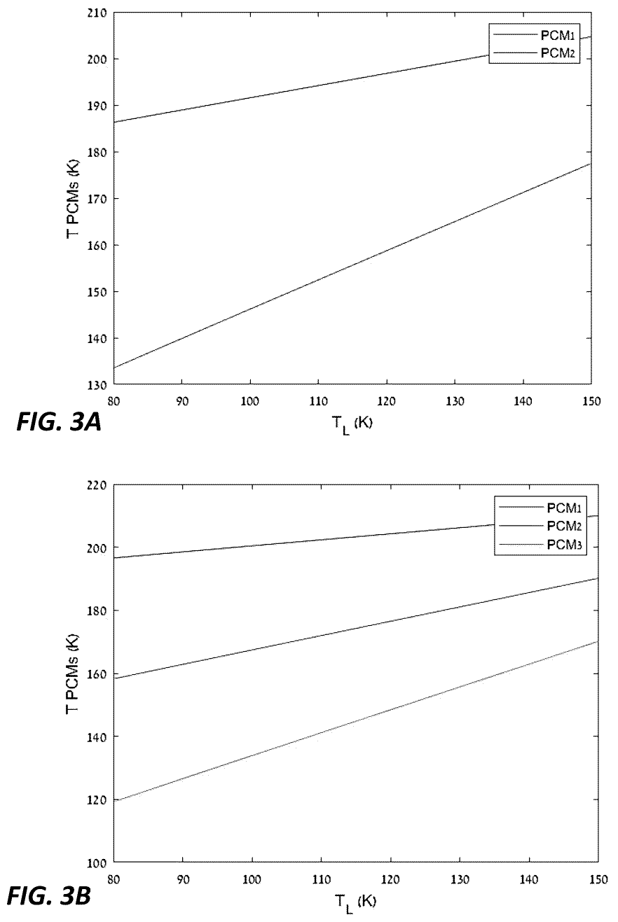

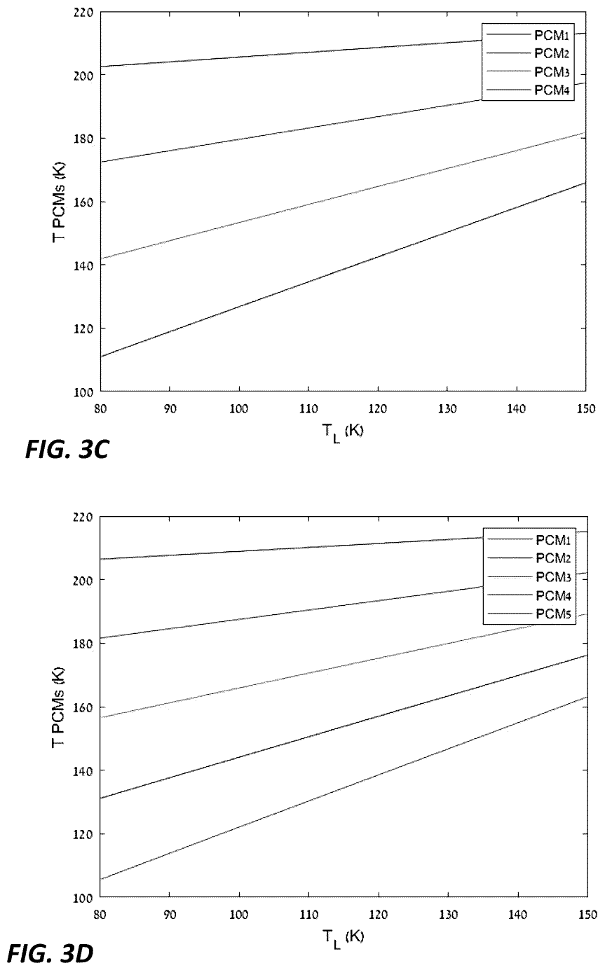

In some embodiments, when more than one PCM unit is included in systems 100, 200 and 300, the temperature as function of the number of PCM units N may be determined based on equations (1)-(n) disclosed herein above. Graphical representations of such calculations of the temperature at the entrance vs. the temperatures at the exit for each PCM unit in systems of 2, 3, 4 and 5 PCM units are given in FIGS. 3A, 3B, 3C and 3B.

For example, when 100, 200, and 300 include two PCM units 120a, and 120b, the temperature of PCM unit 120a is between 100 to 250 K and the temperature of PCM unit 120b is 50 to 200 K. In another example, when 100, 200 and 300 include three PCM units 120a, 120b and 120c, the temperature of PCM unit 120a is between 150 to 250 K, the temperature of PCM unit 120b is 100 to 200 K and the temperature of PCM unit 120c is between 50 to 180 K. In another example, when 100, 200 and 300 include four PCM units 120a, 120b, 120c, and 120d, the temperature of PCM unit 120a is between 200 to 250 K, the temperature of PCM unit 120b is 170 to 200 K, the temperature of PCM unit 120c is between 140 to 180 K and the temperature of PCM unit 120d is between 50 to 160 K. In another example, when 100, 200 and 300 include five PCM units 120a, 120b, 120c, 120 d and 120de, the temperature of PCM unit 120a is between 210 to 250 K, the temperature of PCM unit 120b is 180 to 210 K, the temperature of PCM unit 120c is between 160 to 180 K, the temperature of PCM unit 120d is between 130 to 165 K and the temperature of PCM unit 120e is between 50 to 160 K.

In step 240, the cooled hydrogen temperature is further reduced to between 20 to 180 K, using one of a cooler or a turbine, for example, the hydrogen temperature may be reduced by cooler 230 or turbine 130. In some embodiments, the method may include generating electrical energy by a generator axially connected to the turbine.

In step 260, the hydrogen may be compressed to a pressure level of at most 80 bar, at one of: prior to the cooling by the one or more PCM units, and after cooling by a cooler. The compressor may compress the hydrogen to a pressure of between 2 to 80 bars, or nay value in-between.

In step 280, the hydrogen having a pressure of at most 80 bar and a temperature of between 20 to 180 K, may be stored in HSB storage. For example, the hydrogen may be stored in HSB storage 140.

The hydrogen flow during steps 220 to 280 is shown by the left arrows in FIGS. 1A-1C.

In some embodiments, the method may include recovering the hydrogen stored in HSB 140. In some embodiments, the hydrogen may be discharged from HSB 140.

Following the discharging, the hydrogen may be heated up by one or more PCM units staring from unit 120n to PCM unit 120a, up to the first temperature. The process of heating is the reverse process of cooling as indicated by the left arrows in FIGS. 1A-1C. In some embodiments, heating the hydrogen via PCM units 120a-120n may re-cool the PCMs making them ready for another cooling cycle. In some embodiments, the heated hydrogen may be decompressed to an exit pressure of 1 to 15 bars using an exit turbine, for example, turbine 150. In some embodiments, HSB storage 150 may be heated during the discharge phase, for example, to a temperature of maximum 250 K.

In some embodiments, the method may further include generating electrical energy by a generator axially connected to the exit turbine. In some embodiments, the decompressed hydrogen may be provided to one or more fuel cells for generating electrical energy.

Systems (e.g., systems 100, 200 and 300) according to embodiments of the invention can provide highly efficient storage/recovery process for hydrogen, since in addition to the direct production of electricity from the hydrogen using a fuel cell, one or more turbines included in the system can produce additional electricity when axially connected to a generator.

In a nonlimiting example, the efficiency can be calculated from equation 1-a.

$$η = \frac{L H V - {W}_{s y s}}{L H V} \qquad ( 1 - a )$$

Where LHV is the hydrogen's lower heating value (120 MJ/kg) and Wsys is the system's total work consumption [MJ/kg].

Reference is now made to FIGS. 4A and 4B which include graphs showing the process efficiency versus different storage temperatures and PCMs configurations for 2-5 PCMs systems. The graphs of FIG. 4A show the process efficiency versus storage temperature and PCMs stages only, excluding recovered work (e.g., electricity produced by the generators connected to the turbines). The graphs of FIG. 4B show process efficiency versus storage temperature and PCMs stages, including recovered work.

The total efficiency of the system can be calculated from equation 1-b.

$${η}_{t} = η \cdot {η}_{e l e} \cdot {η}_{fc} \qquad ( 1 - b )$$

Where ηₑₗₑ is the electrolyser (that produced the hydrogen) efficiency (80%) and η_{fc} is the fuel cell efficiency (80%).

Reference is now made to FIGS. 4A and 4B which include graphs showing the total efficiency versus different storage temperatures and PCMs configurations for 2-5 PCMs systems. The graphs of FIG. 4C show the total efficiency versus storage temperature and PCMs stages, excluding recovered work. The graphs of FIG. 4D show the total efficiency versus storage temperature and PCMs stages, including recovered work. As one can see the total efficiency of a system with 5 PCMs is between 61% to 65%. The higher the number of PCM used, the higher is the efficiency, especially at lower storage temperatures (e.g., below 115 K).

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A system for storing and recovering hydrogen, comprising:
a hydrogen inlet,
a first phase change material (PCM) unit configured to regenerate the hydrogen to a first temperature;
a compressor fluidically connected at one of:
between the hydrogen inlet and the first PCM unit, for providing a first pressure level to the hydrogen; or
to the at least the first PCM unit via a cooler for providing the first pressure level to a cooled hydrogen, and
a hydrogen sorbent bed (HSB) storage configured to receive a depressurized cooled hydrogen from one of, the first PCM unit or the compressor,
wherein the hydrogen pressure level at the entrance to the HSB storage is at most 80 bar and the temperature at the entrance to the HSB storage is between 20 to 180 K.

2. The system of claim 1, wherein when the compressor is fluidically connected to the hydrogen inlet, the system further comprises a turbine configured to reduce the pressure of the hydrogen to 2-80 bar and the temperature to between 50 to 180 K.

3. The system of claim 2, wherein the compressor is configured to compress the hydrogen to a pressure between 50 to 700 bar.

4. The system of claim 2, further comprising a generator axially connected to the first turbine, for generating electrical energy.

5. The system of claim 1, wherein when the compressor is fluidically connected to the hydrogen inlet, the system further comprises a cooler fluidically connected to the first PCM unit configured to reduce the temperature of the hydrogen to between 20 to 180 K and wherein the compressor increases the pressure of the hydrogen to 2-80 bar.

6. The system of claim 1, wherein when the compressor is fluidically connected to the at least the first PCM unit via a cooler, the compressor is configured to increase the pressure of the hydrogen to 2-80 bar and the cooler configured to reduce the temperature of the hydrogen to between 20-180 K.

7. The system according to claim 1, wherein the first temperature is between 50 to 250 K.

8. The system according to claim 1, further comprising a second PCM unit configured to regenerate the hydrogen to a second temperature, in fluid connection with the first PCM unit.

9. The system of claim 8, wherein the first temperature is between 100 to 250 K and the second temperature is between 50 to 200 K.

10. The system of claim 8, further comprising a third PCM unit configured to regenerate the hydrogen to a third temperature, in fluid connection with the second PCM unit.

11. The system of claim 10, wherein the first temperature is between 150 to 250 K, the second temperature is between 100 to 200 K and the third temperature is between 50 to 180 K.

12. The system according to claim 1, comprising N PCMs, and wherein the temperature Tₙ of the n PCM is determined from:
$${\int }_{{T}_{n - 1}}^{{T}_{n}} {c}_{p} d T - {\int }_{{T}_{n}}^{{T}_{storage}} {c}_{p} d T = 0 ,$$
where cₚ is the hydrogen specific heat capacity in
$$( \frac{J}{k g K} ) ,$$
T_{storage} is the required temperature at the HSB storage, and n=N and wherein N is an integer.

13. The system according to claim 1, further comprising an exit turbine or a pressure reduction valve in fluid connection to the first PCM unit and configured to receive hydrogen stored in the hydrogen storage and reheated by the first PCM unit.

14. The system of claim 10, wherein the exit turbine or the pressure reduction valve is configured to reduce the pressure of the heated stored hydrogen to 1 to 15 bar.

15. A method of storing and recovering hydrogen, comprising:
cooling by one or more PCM units hydrogen to a first temperature;
reducing the cooled hydrogen to between 20 to 180 K, using one of a cooler or a turbine;
compressing hydrogen to a pressure level of 2-80 bar, at one of: prior to the cooling by the one or more PCM units, and after cooling by a cooler; and
storing the hydrogen having a pressure of 2-80 bar and a temperature of between 50 to 180 K in hydrogen sorbent bed (HSB) storage.

16. The method of claim 15, wherein compressing the hydrogen is by one of: a compressor receiving the hydrogen from a hydrogen source prior to the cooling by the first PCM, or by a compressor located after the cooler.

17. The method of claim 15, further comprising generating electrical energy by a generator axially connected to the turbine.

18. The method according to claim 15, wherein the first temperature is between 50 to 250 K.

19. The method according to claim 15, further comprising cooling the hydrogen from the first PCM by a second PCM to a second temperature.

20. The method of claim 19, wherein the first temperature is between 100 to 250 K and the second temperature is between 50 to 200 K.

21.-28. (canceled)
